(19) United States
(12) Patent Application Publication
(10) Pub. No.: US 2004/0043503 A1
(43) Pub. Date: Mar. 4, 2004

(54) Automatic mass spectrometry analytical system for the quantitative detection of organic toxicant exposure in the human body

(75) Inventors: Po-Chi Liao, Tainan (TW); Lung-Cheng Lin, Fengyuan City (TW); Chien-Ming Li, Yungkang City (TW); Tung-Sheng Shih, Shijr City (TW)

Correspondence Address: BACON & THOMAS, PLLC, 625 SLATERS LANE, FOURTH FLOOR, ALEXANDRIA, VA, 22314

(73) Assignee: INSTITUTE OF OCCUPATIONAL SAFETY AND HEALTH, Shijr City (TW)

(21) Appl. No.: 10/318,004

(22) Filed: Dec. 13, 2002

(30) Foreign Application Priority Data
Aug. 27, 2002 (TW) 91119447

(51) Int. Cl. G01N 24/00

(52) U.S. Cl. 436/173; 436/140; 436/177; 436/178; 250/281; 250/282

(57) ABSTRACT

An automatic mass spectrometry analytical system was developed for the quantitative detection of organic toxicant exposure in the human body. A cartridge (such as C18 cartridge) is integrated into the automatic mass spectrometry analytical system. The sample undergoes sample pretreatment by the cartridge before entering the mass spectrometry for analysis. This increases the accuracy and sensitivity of analysis, while also avoiding tedious manual sample pretreatment procedures. The whole analytical process is fully automatic and therefore useful for high throughput sample analysis.

### BACKGROUND OF THE INVENTION

1. Field of the Invention

An automatic mass spectrometry analytical system was developed for the quantitative detection of organic toxicant exposure in the human body. A cartridge is integrated into the automatic mass spectrometry analytical system. The sample undergoes on-line sample pretreatment by the cartridge before entering the mass spectrometry for analysis. The system is useful for high throughput sample analysis.

2. Description of the Prior Art

Benzene is a widely used industrial chemical. It is a component of gasoline, solvents, etc., a constituent of engine emission and tobacco smoke, as well as a ubiquitous environmental pollutant. Those chronically exposed to a benzene-polluted environment include petrochemical industry workers, gas station attendants and smokers. Several lines of evidence have suggested a close relationship between exposure to benzene and the occurrence of various types of leukemia. The International Agency for Research on Cancer (IARC) has classified benzene as a Group 1 carcinogen.

The metabolism of benzene has been widely studied, yielding S-phenyl mercapturic acid (S-PMA), trans, trans-muconic acid (t, t-MA), glucuronide, sulfate conjugates of phenol, hydroquinol, catechol and 1,2,4-trihydroxybenzene [J chromatogr B. 660:1-22, 1994, Brit. J. Ind. Med. 48:437-444, 1991] in human urine. The selection of valid exposure biomarkers relies on specificity with respect to the toxic substances and on the sensitivity of the analytical procedure. The validity exposure biomarkers for benzene have been evaluated and reviewed [Crit. Rev. Toxicol. 29:129-168, 1999]. Among benzene and its metabolites described above, S-PMA is an optimized biomarker that provides the best specificity and analytical reliability for detection of benzene exposure in the human body [Occup. Environ. Med. 52:611-620, 1995].

Most conventional methods use total phenol volume in urine as the occupational exposure biomarker for benzene. However, this indication is limited to benzene exposure concentration higher than 5 ppm. Many countries have reduced the occupational exposure concentration of benzene to 1 ppm or less. A biomarker with greater specificity and which is applicable to lower exposure concentration is thus required. S-PMA provides higher applicability than the benzene biomarkers that have been used in the past. Several analytical methods, such as high performance liquid chromatography (HPLC) with ultraviolet absorption detection [J. Chromatogr. 620:239-242, 1995]; HPLC with fluorescence detection [J. Chromatogr. 697:371-375, 1995]; gas chromatography with flame ionization detection [Int. Arch. Occ. Env. Hea. 67:195-200, 1995]; and gas chromatography-tandem mass spectrometry (GC-MS) [J. Anal. Toxicol. 11:100-104, 1987], have been proposed and examined for the determination of urinary S-PMA. However, these methods either lack necessary sensitivities (UV absorption detection, flame ionization detection) for assessing low benzene exposure levels, or require tedious chemical deviation procedures in the sample pretreatment (fluorescence detection, gas chromatography).

Besides the detection of benzene exposure as described above, the detection of other organic toxicant exposure in the human body is also important. The development of an analytical system with high sensitivity, lower detection limit and fast analytical speed would assist in solving the known technical problems.

### SUMMARY OF THE INVENTION

The purpose of this invention is to provide an automatic mass spectrometry analytical system for quantitative detection of organic toxicant exposure in the human body. Specifically, a cartridge is integrated into the automatic mass spectrometry analytical system. The sample undergoes sample pretreatment by the cartridge before entering the mass spectrometry for analysis. With no tedious manual sample pretreatment procedures, the analytical system is fully automatic and therefore useful for high throughput sample analysis.

To achieve the purpose described above, this invention is related to an automatic mass spectrometry analytical system for the quantitative detection of organic toxicant exposure in the human body comprises an autosampler for loading samples, a cartridge for sample pretreatment, a switching unit to control the elution direction of fluid, a mass spectrometry for detecting ion signals produced from the sample, and a control device for controlling this analytical system and mass spectrometry signal acquisition.

The autosampler comprises a pump for driving the fluid, an auto-loading device to automatically load the sample into the injector, and an injector to load the sample into subsequent devices.

The cartridge is placed before the mass spectrometry for on-line sample pretreatment. The cartridge is loaded with a specific substance for sample pretreatment; for example, a cartridge loaded with reverse phase C18 stationary phase. Appropriate load may be selected for the cartridge based on the property of samples, for instance, hydrophilic or hydrophobic substance.

The switching unit can be a two-position switching valve used to switch the elute direction of fluid so the fluid can elute the sample into the cartridge (that is, load/wash position) or into the mass spectrometry (elute position).

Electrospray ionization tandem mass spectrometry (ESI-MS/MS) is a preferable selection for the mass spectrometry described above.

The control device is a computer for controlling each device in the system and acquisition of signals from mass spectrometry detection.

One of the embodiments is to provide a method for quantitative detection of benzene exposure in the human body. The method comprises collecting samples, placing the sample into the autosampler, proceeding with on-line sample pretreatment through the cartridge, and loading the sample on cartridge to the mass spectrometry for detection of metabolite signals of benzene, and to estimate the amount of quantitative exposure of benzene in the human body.

Samples for detection can be blood, urine or other specimens, where urine is an optimal specimen.

Benzene metabolites include S-PMA, trans, trans-muconic acid, glucuronide, sulfate conjugates of phenol, catechol, and 1,2,4-trihydroxybenzene.

The benzene metabolites can be used as biomarkers in detecting benzene exposure in the human body, where S-PMA is optimal.

A solid phase extraction cartridge can be used for the cartridge described above with C18 as an optimal choice.

Pretreatment procedures include removing interfering components, such as salt, to avoid interference with subsequent mass spectrometry analysis; this also has a pre-concentration effect on the sample.

### BRIEF DESCRIPTION OF THE DRAWINGS

FIG. 1 illustrates an automatic mass spectrometry analytical system of this invention used for quantitative detection of organic toxicant exposure in the human body.

FIG. 2(A) illustrates sample load/wash position of System 100 of this invention.

FIG. 2(B) illustrates sample elute position of System 100 of this invention.

FIG. 3(A) illustrates a mass spectrometry graph of deprotonated S-PMA detected by this automatic mass spectrometry analytical system.

FIG. 3(B) illustrate a mass spectrometry graph of deprotonated internal standard (N-tBOC-S-(p-methyl-benyl)-L-cysteine) detected by this automatic mass spectrometry analytical system.

FIG. 4(A) illustrates an elution profile of m/z=103 S-PMA detected by this automatic mass spectrometry analytical system after the urine sample is spiked with 1.0 μg/L of S-PMA and internal standard.

FIG. 4(B) illustrates an elution profile of m/z=137 internal standard detected by this automatic mass spectrometry analytical system after the urine sample is spiked with 1.0 μg/L of S-PMA and internal standard.

FIG. 5 illustrates a plot of signal intensity of S-PMA vs. washing time after urine sample is prepared by the on-line sample pretreatment process of this invention.

FIG. 6 illustrates a calibration curve established by this automatic mass spectrometry analytical system.

FIG. 7 illustrates an elution profile of trans, trans-muconic acid detected using this automatic mass spectrometry analytical system.

### DETAILED DESCRIPTION OF THE INVENTION

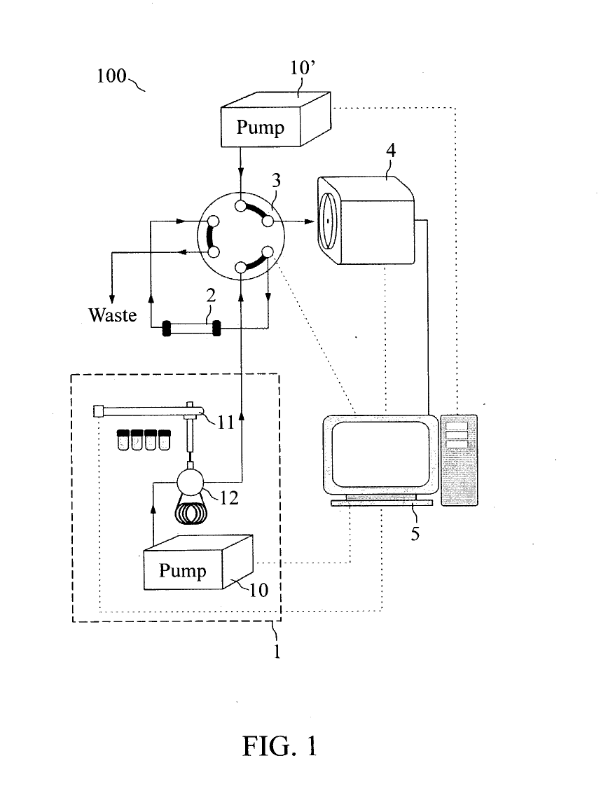

This is an invention of automatic mass spectrometry analytical system for quantitative detection of organic toxicant exposure in the human body. Its advantages and characteristics will be explained in detail with figures for further understanding. Firstly, FIG. 1 shows the automatic mass spectrometry analytical system 100 for quantitative detection of organic toxicant exposure in the human body. It comprises an autosampler 1, for loading samples; a cartridge 2, for sample pretreatment; a switching unit 3, such as a valve, to control the elute direction of fluid; a mass spectrometry 4, to detect the ion signals produced from the sample; and a control device 5, for controlling this analytical system and mass spectrometry signal acquisition.

The autosampler 1 comprises a pump 10, to activate the fluid; an auto sample loader 11, to automatically load the sample into the injector; and an injector 12, used to inject the sample into subsequent devices. Operation procedures of this invention are described as follows.

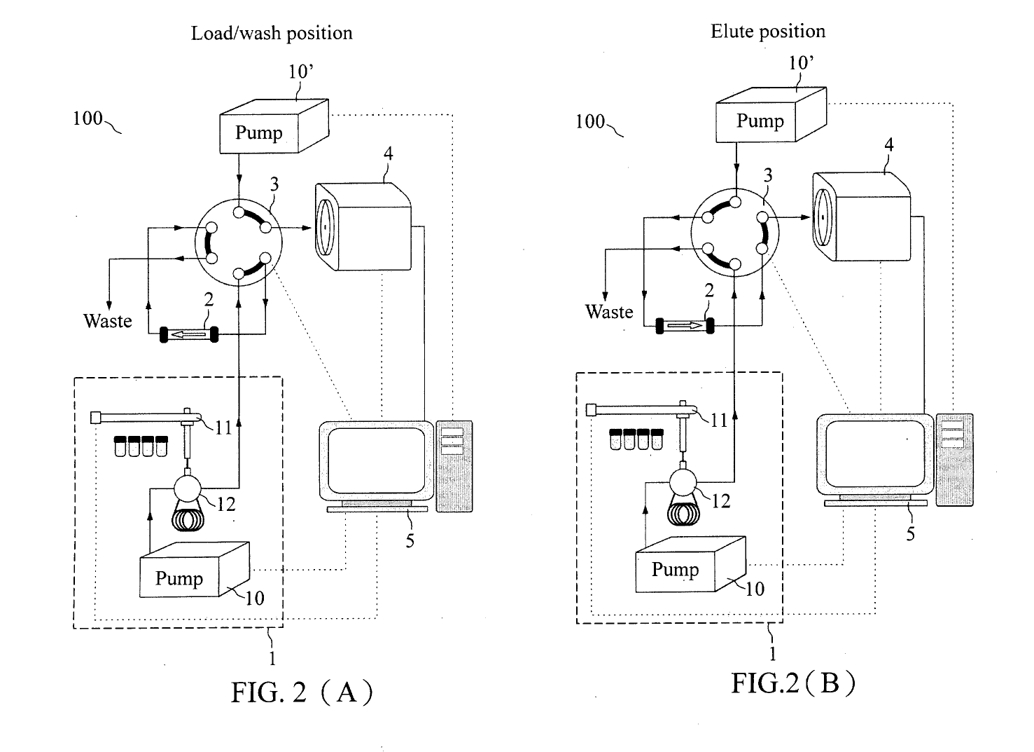

FIG. 2(A) is the sample load/wash position of System 100 of this invention. When performing sample analysis, samples (such as urine) are passed through the filtration membrane before being placed into the auto sample loader 11 of autosampler 1. Control device 5 is used to automatically load the sample into injector 12. The pump 10 introduces the sample into cartridge 2 through the switching unit 3 (valve) for sample pretreatment process (such as removal of salts and other components). The operation procedures in FIG. 2(A) (along arrows) show that when switching unit 3 is in the load/wash position, the sample is retained on the cartridge 2. Hydrophilic components are removed to avoid interference with subsequent mass spectrometry detection. This process is the on-line sample pretreatment procedure.

The procedure in FIG. 2(B) can proceed after the sample pretreatment procedures described in FIG. 2(A). FIG. 2(B) shows that, after the switching unit 3 is switched to the elute position, the prepared sample is eluted by the other pump 10′ along the direction shown by the arrow in the figure, and loaded into spectrometry 4 for analysis. Control device 5 then processes signals acquired from final analysis and performs data output.

The operation procedures described above are for automatic mass spectrometry analytical system 100 of this invention used for quantitative detection of organic toxic exposure in the human body. By using the following embodiments, applications of this invention are further explained in detail below.

Embodiment 1 Provides a Method to Detect the Quantitative Exposure of Benzene in the Human Body (S-PMA).

Urine Samples Preparation

The collected urine samples were passed through 0.2 μm filtration membranes. An aliquot of 400 μL of filtered urine was firstly mixed with 1001L of 20% acetic acid and 100 μL of 1000 μg/L internal standard (IS), N-t-BOC-S-(p-methyl-benyl)-L-cysteine, with a known amount of S-PMA added when spiking experiments were performed, and diluted with 1400 μL of deionized water. From the total volume of 2000 μL, 200 μL of aliquot was injected into the analytical system (FIG. 1) for analysis. No other sample pretreatment procedures were performed or required other than the filtration described above. This can greatly simplify preparation procedures and save time.

On-Line Sample Pretreatment and Elute Procedures

Samples were loaded onto the C18 cartridge 2 (particle size 3 μm) by the pump 10 of autosampler 1 (as shown in FIG. 1) using 100% water at 0.6 mL/min, and were washed with 100% water for optimization time of 12 minutes (1.0, 2.0, 3.0, 4.0, 5.0, 6.0, 7.0, 8.0, 10.0, 12.0, 13.0, 14.0). This is to remove highly hydrophilic components of the urine samples to avoid interference with the subsequent detection results of spectrometry 4. The switching unit 3 (valve) was then activated to the Elute position and the sample was eluted with 1.0 mL/min 100% methanol provided by pump 10′ from cartridge 2 into the mass spectrometry 4 for analysis.

The mass spectrometry used in this invention is the API 365 Triple Quadrupole MS/MS.

Optimization of Sample Pretreatment

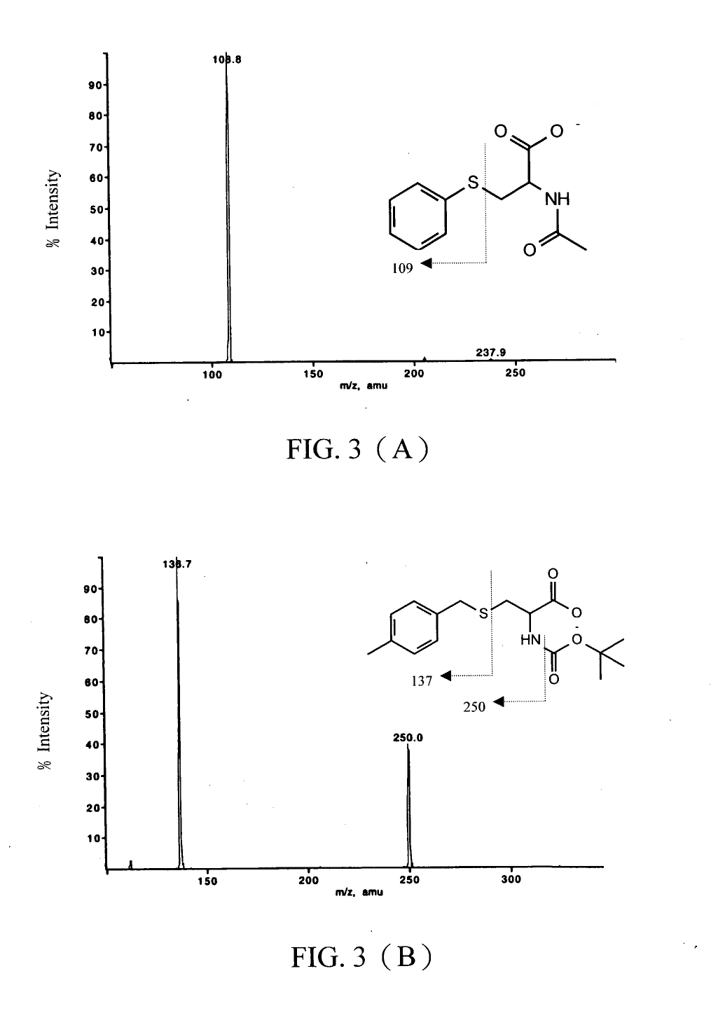

FIGS. 3(A) and 3(B) show the mass spectra of deprotonated S-PMA and its internal standard, N-t-BOC-S-(p-methyl-benyl)-L-cysteine, detected using the automatic mass spectrometry analytical system of this invention. N-t-BOC-S-(p-methyl-benyl)-L-cysteine was used as the internal standard for the quantitative detection of S-PMA because of its structural similarity to S-PMA and commercial availability. FIGS. 3(A) and 3(B) showed that product ion of S-PMA at m/z=109 and internal standard at m/z=137 have the most intense signals. Therefore, these two ion signals were chosen for subsequent monitoring.

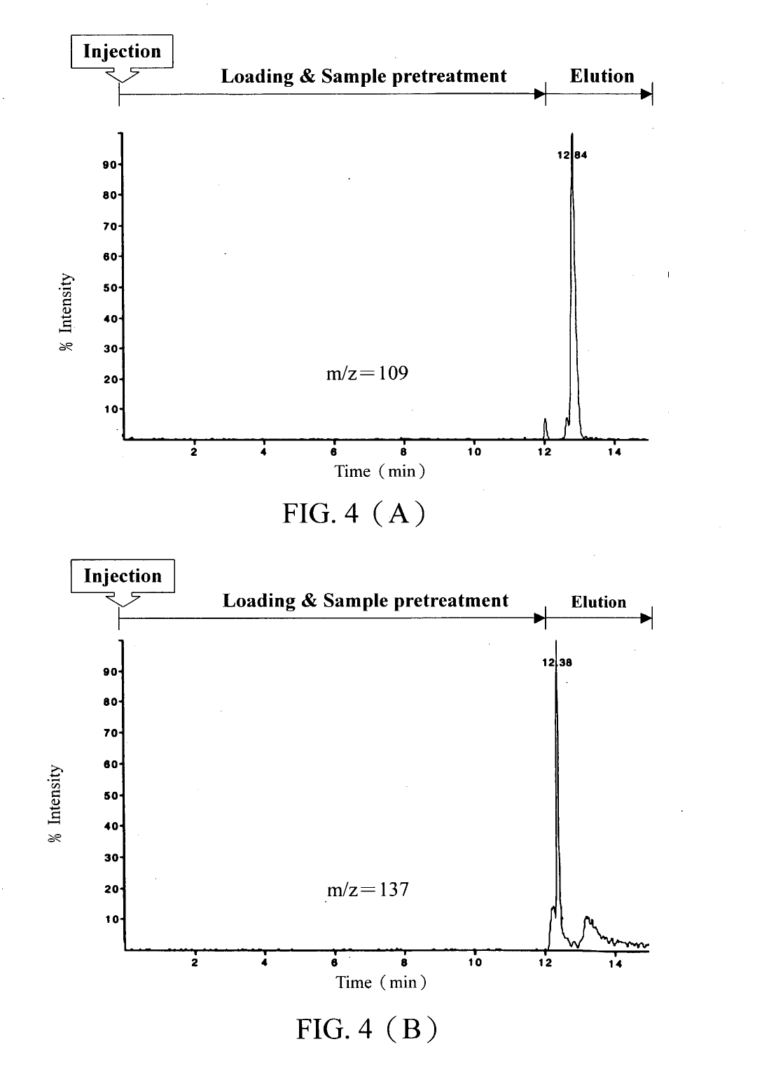

FIGS. 4(A) and 4(B) are the elution profiles of S-PMA at m/z=109, and internal standard, m/z=137 respectively when a urine sample containing 1.0 μg/L of spiked S-PMA and internal standard was analyzed by the automatic mass spectrometry analytical system. The urine sample was washed in the cartridge with 100% water for 12 minutes. Through the switching unit, the urine sample inside the cartridge was eluted with 100% methanol into the mass spectrometry for analysis. FIGS. 4(A) and 4(B) showed that the internal standard was eluted, followed by S-PMA.

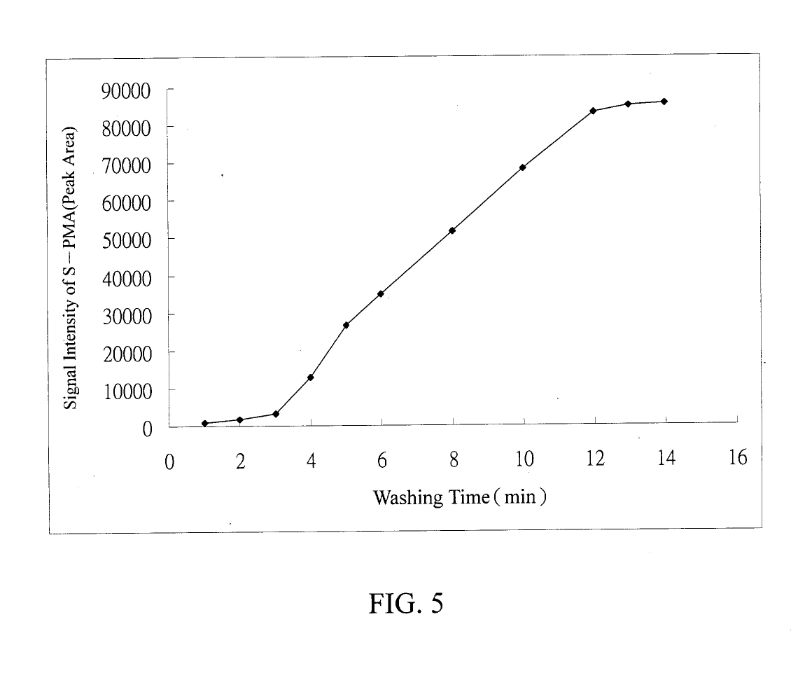

The washing time for the urine sample pretreatment on cartridge was investigated (that is, the cartridge was washed using 100% water) to reveal the optimal washing time. The urine sample was washed on the cartridge for 1.0, 2.0, 3.0, 4.0, 5.0, 8.0, 10.0, 12.0, 13.0 and 14.0 minutes. FIG. 5 shows that when washing time was below 3 minutes, little S-PMA signal was detected, presumably due to the signal suppression effect caused by the presence of excessive salt content in the ESI/MS/MS process. S-PMA signal intensity increased with washing time if the washing time was greater than 3 minutes until a saturation effect was observed when the washing time was 12 minutes or greater. Therefore the optimal elution time is 12 minutes.

Establishment of Calibration Curve

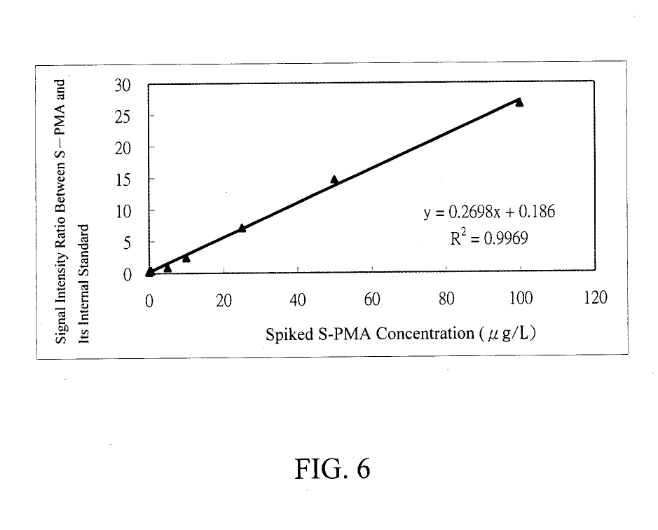

A calibration curve can be established from the experiment described above. As shown in FIG. 6, the calibration curve gives the equation y=0.2698x+0.186, R²=0.997, where y is the signal intensity ratio between S-PMA and its internal standard and x is the spiked internal standard concentration (μg/L). The detection limit for neat S-PMA standard solution of the method was determined to be 0.04 μg/L.

Embodiment 2 Detection of Six Neonates and Six Adults Using This System

Using the process described in Embodiment 1 above, this invention was used to establish the optimal experimental mode of quantitative detection of organic toxicant exposure in the human body using an automatic mass spectrometry analytical system. This Embodiment is to analyze the S-PMA concentration in urine samples collected from six neonates and six adults in the same hospital; the results are listed in Table 1. In the automatic mass spectrometry analytical system of this invention, each analysis took less than 18 minutes, and therefore 80 urine samples could be analyzed within 24 hours. The trap cartridge employed in the analytical system was reusable and showed no noticeable degradation of performance after 100 analyses.

TABLE 1

| Sample Group | S-PMA (μg/L) | Arithmetic Mean | Standard deviation |
|---|---|---|---|
| Neonate 1 | 0.249 | | |
| Neonate 2 | 0.345 | | |
| Neonate 3 | 0.322 | | |
| Neonate 4 | 0.365 | 0.331 μg/L | 0.043 μg/L |
| Neonate 5 | 0.356 | | |
| Neonate 6 | 0.348 | | |
| Adult 1 | 0.560 | | |
| Adult 2 | 1.268 | | |
| Adult 3 | 1.411 | | |
| Adult 4 | 4.196 | 1.614 μg/L | 1.300 μg/L |
| Adult 5 | 0.993 | | |
| Adult 6 | 1.255 | | |

• All adults are non-smokers

Embodiment 3 Provide a Method for Quantitative Detection of Benzene Exposure in the Human Body (t,t-MA)

The Embodiment 1 described above involved the quantitative detection of benzene exposure biomarker S-PMA in human urine. This experiment uses this development system to detect another benzene exposure biomarker, t,t-MA, in human urine. The system and procedures (as shown in FIG. 1) used in this experiment are the same as those described in Embodiment 1 where the elution liquid driven by pump 10 was water at 600 μl/min, and that driven by pump 10′ was methanol at 600 μl/min. The sample was loaded into cartridge 2, then washed for 2 minutes with the water from pump 10, then switch to pump 10′ and washed with methanol for 5 minutes.

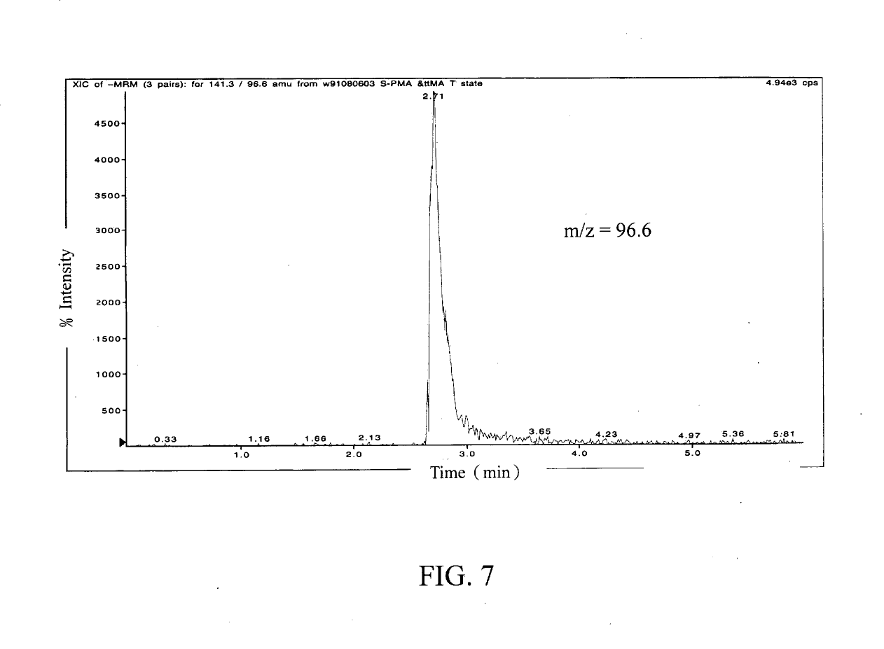

FIG. 7 is the elution profile of t,t-MA of precursor ion m/z=141.3, product ion m/z=96.6 detected by this automatic mass spectrometry analytical system. The figure shows that this development system could pre-concentrate the t-t-MA and achieve excellent detection results after cartridge sample pretreatment.

The experiments proved that this invention of automatic mass spectrometry analytical system could widely perform quantitative detection of all types of organic toxicant exposure in the human body. These experiments were performed individually to detect specified compounds. However, this invented system is not limited to those experiments described above. It also can simultaneously detect several types of organic toxicant in the human body to achieve fast and accurate analysis.

By comparison with conventional analytical techniques, this invention of automatic mass spectrometry analytical system used for quantitative detection of organic toxicant exposure in the human body has the following advantages. It can perform on-line sample pretreatment process, uses an automated process from sample loading to final analysis result acquisition, has high sensitivity and reduced detection limit, and greatly decreases analysis time. These advantages mean that the system can effectively improve the quantitative detection of organic toxicant exposure in the human body.

What is claimed is:

1. An automatic mass spectrometry analytical system used for quantitative detection of organic toxicant exposure in the human body comprises:
an autosampler, for loading samples;
a cartridge, for sample pretreatment;
a switching unit, to control the elution direction of fluid;
a mass spectrometry, for detecting the ion signal produced from the sample; and
a control device, to control the analytical system and proceed with signal acquisition from the mass spectrometry.

2. The automatic mass spectrometry analytical system of claim 1, wherein the autosampler comprises a pump, to activate the fluid; an auto sample loader, to automatically load the sample into injector; and an injector, used to inject the sample into subsequent preparation devices.

3. The automatic mass spectrometry analytical system of claim 1, wherein the cartridge is placed before the mass spectrometry for on-line sample pretreatment.

4. The automatic mass spectrometry analytical system of claim 1, wherein the cartridge can be loaded with a hydrophilic or hydrophobic substance.

5. The automatic mass spectrometry analytical system of claim 1, wherein the cartridge may be a C18 cartridge.

6. The automatic mass spectrometry analytical system of claim 1, wherein the switching unit is a valve and is used to change the elution direction of fluid so the fluid can elute the sample onto a cartridge or the mass spectrometry.

7. The automatic mass spectrometry analytical system of claim 1, wherein the mass spectrometry preferable is an electrospray ionization tandem mass spectrometry.

8. The automatic mass spectrometry analytical system of claim 1, wherein the control device is a computer.

9. A method of quantitative detection of benzene exposure in the human body comprises:
collecting samples;
placing the sample into said autosampler;
proceeding with on-line sample pretreatment using said cartridge;
loading the sample on cartridge to the mass spectrometry and detecting the metabolism signal of benzene in the sample; and
estimating the quantity of benzene exposure in the human body.

10. The method of claim 9, wherein the sample to be analyzed may be blood, urine or other specimen.

11. The method of claim 10, wherein the preferable sample for analysis is urine.

12. The method of claim 9, wherein said benzene metabolites comprise: S-PMA, trans, trans-muconic acid, glucuronide, sulfate conjugates of phenol, catechol and 1,2,4-trihydroxybenzene.

13. The method of claim 12, wherein the benzene metabolites can be used as benzene exposure biomarkers in the human body.

14. The method of claim 13, wherein said benzene metabolites preferable is S-PMA.

15. The method of claim 9, wherein the cartridge may be a solid phase extraction cartridge.

16. The method of claim 15, wherein the cartridge preferable is C18 cartridge.
